(19) United States
(12) Patent Application Publication
(10) Pub. No.: US 2024/0184864 A1
(43) Pub. Date: Jun. 6, 2024

(54) REMOTE SUPPORT TERMINAL AND TERMINAL CONTROL METHOD

(71) Applicant: TOYOTA JIDOSHA KABUSHIKI KAISHA, Toyota-shi (JP)

(72) Inventors: Yuki SUEHIRO, Susono-shi (JP); Rio SUDA, Toyota-shi (JP); Hirofumi MOMOSE, Toyota-shi (JP)

(73) Assignee: TOYOTA JIDOSHA KABUSHIKI KAISHA, Toyota-shi (JP)

(21) Appl. No.: 18/483,704

(22) Filed: Oct. 10, 2023

(30) Foreign Application Priority Data
Dec. 6, 2022 (JP) 2022-194931

(51) Int. Cl. G06F 21/31; G05D 1/00; G06F 21/44

(52) U.S. Cl. CPC G06F 21/31; G05D 1/0038; G06F 21/44; G05D 2201/0213

(57) ABSTRACT

A remote support terminal is operated by a user performing a remote support for a moving body. The remote support terminal includes a display and one or more processors. The one or more processors display an authentication screen for requesting authentication of the user on the display. The one or more processors prohibit displaying a remote support screen for the user to perform the remote support for the moving body on the display until the authentication of the user is completed. The one or more processors display the remote support screen on the display after the authentication of the user is completed.

### CROSS-REFERENCES TO RELATED APPLICATION

The present disclosure claims priority to Japanese Patent Application No. 2022-194931, filed on Dec. 6, 2022, the contents of which application are incorporated herein by reference in their entirety.

### TECHNICAL FIELD

The present disclosure relates to a remote support for a moving body. In particular, the present disclosure relates to a remote support terminal operated by a user who performs a remote support for a moving body.

### BACKGROUND ART

Patent Literature 1 discloses remote operation of an autonomous driving vehicle. The autonomous driving vehicle requests a remote operation by a remote operator when a risk exceeds a threshold. The remote operator initiates the remote operation in response to the request from the autonomous driving vehicle.

### LIST OF RELATED ART

Patent Literature 1: U.S. Patent Application Publication No. 2020/0310417

### SUMMARY

When a remote support for a moving body is required, a remote operator operates a remote support terminal. Here, it is necessary to prevent a situation in which an unqualified person operates the remote support terminal without permission to perform the remote support for the moving body. However, Patent Literature 1 does not discuss authentication of a remote operator.

An object of the present disclosure is to provide a technique capable of improving security of a remote support for a moving body.

A first aspect is directed to a remote support terminal operated by a user performing a remote support for a moving body. The remote support terminal includes a display and one or more processors. The one or more processors display an authentication screen for requesting authentication of the user on the display. The one or more processors prohibit displaying a remote support screen for the user to perform the remote support for the moving body on the display until the authentication of the user is completed. The one or more processors display the remote support screen on the display after the authentication of the user is completed.

A second aspect is directed to a terminal control method for controlling a remote support terminal operated by a user performing a remote support for a moving body.

The terminal control method includes:
displaying an authentication screen for requesting authentication of the user on a display of the remote support terminal;
prohibiting displaying a remote support screen for the user to perform the remote support for the moving body on the display until the authentication of the user is completed; and
displaying the remote support screen on the display after the authentication of the user is completed.

According to the present disclosure, the remote support screen for the user to perform the remote support for the moving body is prohibited from being displayed until the authentication of the user is completed. It is therefore possible to prevent a situation in which an unqualified person operates the remote support terminal without permission to perform the remote support for the moving body. As a result, the security of the remote support for the moving body is improved.

### BRIEF DESCRIPTION OF DRAWINGS

FIG. 1 is a schematic diagram illustrating a configuration example of a remote support system according to an embodiment;

FIG. 2 is a block diagram illustrating a configuration example of a remote support terminal according to an embodiment;

FIG. 3 is a block diagram for explaining an example of state transition in the remote support terminal according to an embodiment;

FIG. 4 is a block diagram for explaining another example of state transition in the remote support terminal according to an embodiment; and

FIG. 5 is a flowchart showing processing related to termination of remote driving according to an embodiment.

### DETAILED DESCRIPTION

Embodiments of the present disclosure will be described with reference to the accompanying drawings.

### 1. Remote Support System

A remote support for a moving body is considered. The remote support is a concept that includes remote monitoring, remote assistance, and remote driving. Examples of the moving body include a vehicle, a robot, and the like. The vehicle may be an autonomous driving vehicle or may be a vehicle driven by a driver. Examples of the robot include a logistic robot, a work robot, and the like. As an example, in the following description, a case where the moving body being the target of the remote support is a vehicle will be considered. When generalizing, “vehicle” in the following description shall be deemed to be replaced with “moving body.”

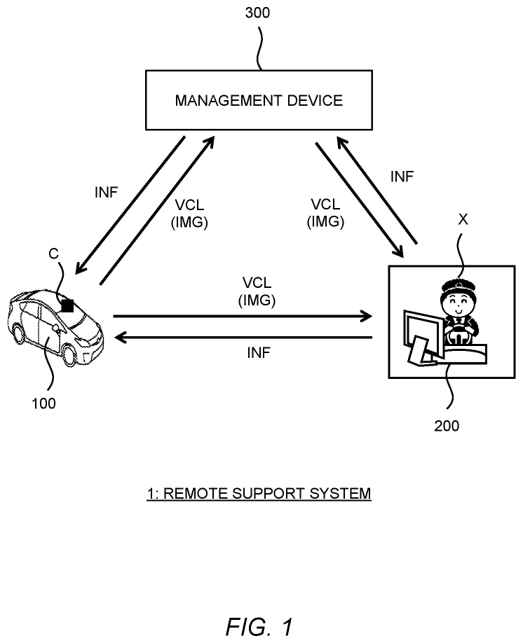

FIG. 1 is a schematic diagram illustrating a configuration example of a remote support system 1 according to the present embodiment. The remote support system 1 includes a vehicle 100, a remote support terminal 200, and a management device 300. The vehicle 100 is a target of the remote support. The remote support terminal 200 is a terminal device operated by a user X (a remote operator) to perform the remote support for the vehicle 100. The remote support terminal 200 may also be referred to as a remote cockpit. The management device 300 manages the remote support system 1. For example, the management device 300 assigns a user X from among a plurality of user candidates to a vehicle 100 being a target of the remote support. Typically, the management device 300 is a management server on a cloud. The management server may be configured by a plurality of servers that perform distributed processing.

The vehicle 100, the remote support terminal 200, and the management device 300 are capable of communicating with each other via a communication network. The vehicle 100 and the remote support terminal 200 can communicate with each other via the management device 300. The vehicle 100 and the remote support terminal 200 may directly communicate with each other without through the management device 300.

Various sensors including a camera C are mounted on the vehicle 100. The camera C images a situation around the vehicle 100 to acquire an image IMG indicating the situation around the vehicle 100. Vehicle information VCL is information acquired by the various sensors and includes the image IMG captured by the camera C. The vehicle 100 transmits the vehicle information VCL to the remote support terminal 200.

The remote support terminal 200 receives the vehicle information VCL transmitted from the vehicle 100. The remote support terminal 200 presents the vehicle information VCL to the user X. More specifically, the remote support terminal 200 includes a display device, and displays the image IMG and the like on the display device. The user X views the displayed information, recognizes the situation around the vehicle 100, and performs the remote support for the vehicle 100. Remote support information INF is information relating to the remote support performed by the user X. For example, the remote support information INF includes an instruction or an operation amount input by the user X. The remote support terminal 200 transmits the remote support information INF to the vehicle 100 as necessary.

The vehicle 100 receives the remote support information INF transmitted from the remote support terminal 200. The vehicle 100 performs vehicle travel control in accordance with the received remote support information INF.

### 2. Configuration Example of Remote Support Terminal

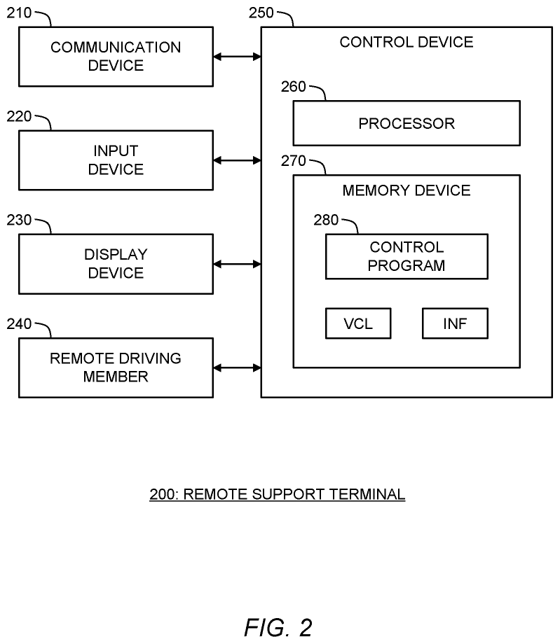

FIG. 2 is a block diagram illustrating a configuration example of the remote support terminal 200. The remote support terminal 200 includes a communication device 210, an input device 220, a display device 230, a remote driving member 240, and a control device (controller) 250.

The communication device 210 communicates with the vehicle 100 and the management device 300.

The input device 220 receives an input from the user X. Examples of the input device 220 include a touch panel, a keyboard, a mouse, and the like.

The display device 230 displays a variety of information. For example, the display device 230 displays a variety of screens to be described later.

The remote driving member 240 is a member operated by the user X when remotely driving the vehicle 100. For example, the remote driving member 240 includes a steering wheel, an accelerator pedal, a brake pedal, a direction indicator, and the like. The remote driving member may be a touch panel.

The control device (controller) 250 controls the remote support terminal 200. The control device 250 includes one or more processors 260 (hereinafter, simply referred to as a processor 260) and one or more memory devices 270 (hereinafter, simply referred to as a memory device 270). The processor 260 executes a variety of processing. For example, the processor 260 includes a central processing unit (CPU). The memory device 270 stores a variety of information necessary for processing by the processor 260. Examples of the memory device 270 include a volatile memory, a nonvolatile memory, a hard disk drive (HDD), a solid state drive (SSD), and the like.

A control program 280 is a computer program executed by the processor 260. The functions of the control device 250 are implemented by the processor 260 executing the control program 280. The control program 280 is stored in the memory device 270. Alternatively, the control program 280 may be recorded on a non-transitory computer-readable recording medium. The control program 280 may be provided via a network.

The control device 250 communicates with vehicle 100 via the communication device 210. The control device 250 receives the vehicle information VCL transmitted from the vehicle 100. The control device 250 presents the vehicle information VCL to the user X by displaying the vehicle information VCL including the image IMG on the display device 230. The user X is able to recognize the state of the vehicle 100 and the surrounding situation based on the vehicle information VCL displayed on the display device 230.

The user X issues a variety of instructions (for example, a start instruction) via the input device 220, as necessary. When performing the remote driving of the vehicle 100, the user X operates the remote driving member 240. An operation amount of the remote driving member 240 is detected by a sensor provided in the remote driving member 240. The control device 250 generates the remote support information INF including the instruction or the operation amount input by the user X. Then, the control device 250 transmits the remote support information INF to the vehicle 100 via the communication device 210.

Hereinafter, state transition in the remote support terminal 200 will be described in more detail.

### 3. State Transition in Remote Support Terminal

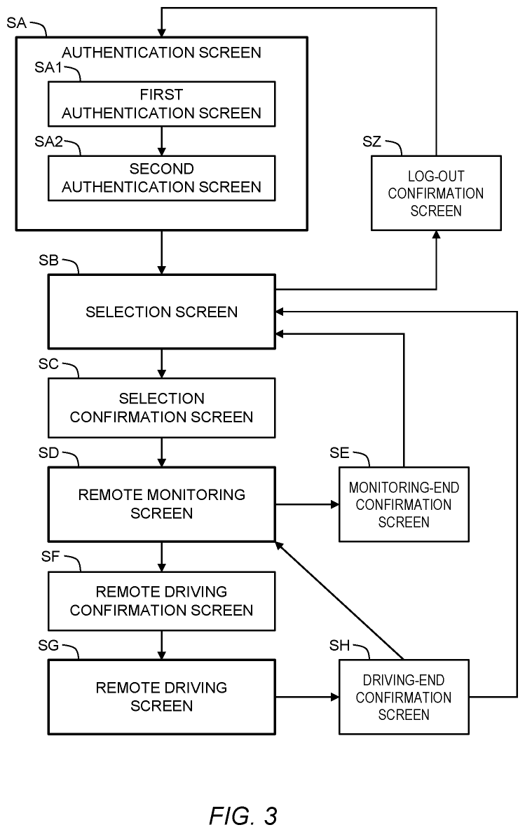

FIG. 3 is a block diagram for explaining an example of the state transition in the remote support terminal 200 according to the present embodiment.

### 3-1. Authentication Screen

First, the control device 250 displays an authentication screen SA on the display device 230. The authentication screen SA is a screen for requesting authentication of the user X. In other words, the authentication screen SA is a screen that prompts the user X to input authentication information for the authentication. The user X inputs the authentication information by the use of the input device 220.

The authentication information input by the user X may be sent to the management device 300. The management device 300 or the remote support terminal 200 holds authentication information related to the user X that is registered in advance. The management device 300 or the remote support terminal 200 compares the authentication information input by the user X with the held authentication information to authenticate the user X. When the authentication results in fail for a predetermined number of times, the control device 250 may display an error notification on the display device 230.

The authentication of user X may be performed in two stages. In this case, the control device 250 first displays a first authentication screen SA1 for the first stage on the display 230. The authentication information in the first stage is set based on, for example, personal information of the user X. For example, the authentication information in the first stage is a combination of a mail address and a password. When the first stage authentication is successful, the control device 250 displays a second authentication screen SA2 for the second stage on the display device 230. That is, the control device 250 switches a display screen from the first authentication screen SA1 to the second authentication screen SA2. Examples of the second stage authentication information include a one-time password, biometric information (e.g., a fingerprint) of the user X, and the like. When the second stage authentication is also successful, the authentication of the user X is completed.

Until the authentication of the user X is completed, the control device 250 prohibits displaying a “remote support screen” on the display device 230. The remote support screen is a screen for the user X to perform the remote support for the vehicle 100, and a variety of examples thereof will be described later. When the authentication of the user X is completed, the control device 250 permits displaying the remote support screen on the display device 230.

### 3-2. Selection Screen

In the example illustrated in FIG. 3, when the authentication of the user X is completed, the control device 250 displays a “selection screen SB,” which is one of the remote support screens, on the display device 230. The selection screen SB is a screen for the user X to select a vehicle 100 to be a target of the remote support.

More specifically, a group of vehicle candidates for which the user X is allowed to perform the remote support is predetermined for each user X. The management device 300 or the remote support terminal 200 holds vehicle candidate information that indicates the allowed group of vehicle candidates for each user X. By accessing the vehicle candidate information, the control device 250 acquires information on the group of vehicle candidates for which the user X is allowed to perform the remote support. The selection screen SB indicates the group of vehicle candidates for which the user X is allowed to perform the remote support.

The user X views the selection screen SB displayed on the display device 230. The user X is able to select (designate) a vehicle 100 to be a target of the remote support from the group of vehicle candidates by the use of the input device 220.

When the vehicle 100 is selected (designated) by the user X, the control device 250 may display a selection confirmation screen SC for confirming the selection on the display device 230. The user X confirms or cancels the selection by the use of the input device 220. When the selection is canceled, the display screen returns to the selection screen SB. On the other hand, when the selection is confirmed, the display screen is switched to a remote monitoring screen SD which will be described next. It should be noted that the selection confirmation screen SC may be omitted.

The ID information of the vehicle 100 selected by the user X is transmitted from the remote support terminal 200 to the management device 300. The management device 300 associates the user X with the selected vehicle 100.

### 3-3. Remote Monitoring Screen

When the vehicle 100 is selected by the user X, the control device 250 displays a “remote monitoring screen SD,” which is one of the remote support screens, on the display device 230. That is, the control device 250 switches the display screen to the remote monitoring screen SD. The remote monitoring screen SD is a screen for the user X to perform the remote monitoring of the vehicle 100. The remote monitoring screen SD includes at least the image IMG captured by the camera C mounted on the vehicle 100. The image IMG is acquired from the vehicle information VCL transmitted from the vehicle 100. The user X monitors the situation around the vehicle 100 by viewing the image IMG.

The user X is able to request termination of the remote monitoring of the vehicle 100 by the use of the input device 220. When the termination of the remote monitoring is requested by the user X, the control device 250 may display a monitoring-end confirmation screen SE for confirming the request on the display device 230. The user X confirms or cancels the request by the use of the input device 220. When the request is cancelled, the display screen returns to the remote monitoring screen SD. On the other hand, when the request is confirmed, the display screen is switched to the above-described selection screen SB. It should be noted that the monitoring-end confirmation screen SE may be omitted.

### 3-4. Remote Driving Screen

The vehicle 100 may issue a “remote driving request (RFO: Request for Operation)” for requesting the remote driving by a remote operator, as necessary. The remote driving request is transmitted from the vehicle 100 to the remote support terminal 200. The remote driving request may be transmitted from the vehicle 100 to the remote support terminal 200 via the management device 300. In response to the remote driving request, the management device 300 may determine a user X who performs the remote driving of the vehicle 100. That is, the management device 300 may assign a user X to the vehicle 100 that has issued the remote driving request.

There is a case where a remote driving request is issued from a vehicle 100 under remote monitoring. Upon receiving the remote driving request from the vehicle 100, the remote support terminal 200 notifies the user X of the remote driving request. In response to the remote driving request, the user X requests start of the remote driving of the vehicle 100. Alternatively, the user X may voluntarily request start of the remote driving of the vehicle 100. In either case, the user X is able to request start of the remote driving of the vehicle 100 by the use of the input device 220.

When the start of the remote driving is requested by the user X, the control device 250 may display a remote driving confirmation screen SF for confirming the request on the display device 230. The user X confirms or cancels the request by the use of the input device 220. If the request is cancelled, the display screen returns to the remote monitoring screen SD. On the other hand, when the request is confirmed, the display screen is switched to a remote driving screen SG. It should be noted that the remote driving confirmation screen SF may be omitted.

The control device 250 displays a “remote driving screen SG,” which is one of the remote support screens, on the display device 230. That is, the control device 250 switches the display screen to the remote driving screen SG. The remote driving screen SG is a screen for the user X to perform the remote driving of the vehicle 100. The remote driving screen SG includes at least the image IMG captured by the camera C mounted on the vehicle 100. The image IMG is obtained from the vehicle information VCL transmitted from the vehicle 100. The user X recognizes the situation around the vehicle 100 by viewing the image IMG and performs the remote driving of the vehicle 100.

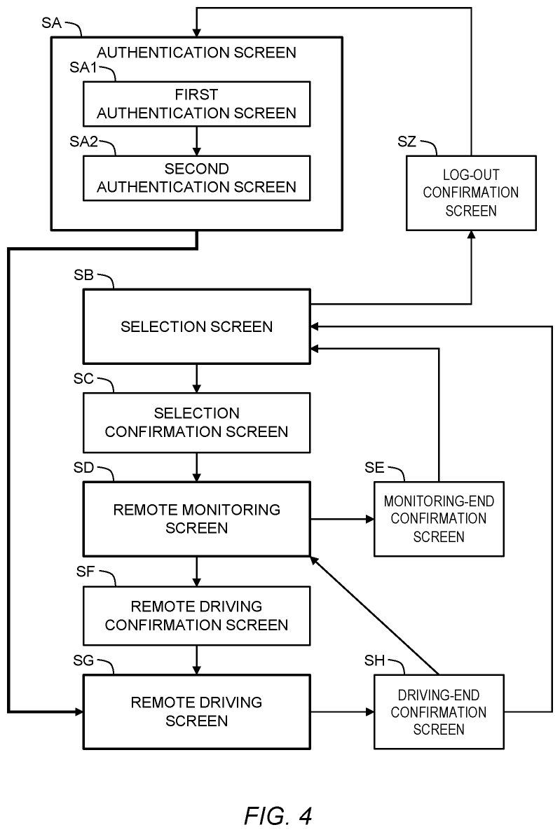

FIG. 4 shows a modification example. In the case of the modification example, the remote support terminal 200 receives a remote driving request from a certain vehicle 100 before the authentication of the user X is completed. In this case, once the authentication of the user X is completed, the control device 250 immediately switches the display screen from the authentication screen SA to the remote driving screen SG. In other words, once the authentication of the user X is completed, the control device 250 immediately displays the remote driving screen SG on the display device 230 without displaying the selection screen SB or the like. As a result, it is possible to quickly start the remote driving of the vehicle 100.

### 3-5. Termination of Remote Driving

The user X is able to request termination of the remote driving of the vehicle 100 by the use of the input device 220. When the termination of the remote driving is requested by the user X, the control device 250 may display a driving-end confirmation screen SH for confirming the request on the display device 230. The user X confirms or cancels the request by the use of the input device 220. When the request is canceled, the display screen returns to the remote driving screen SG.

When the request is confirmed, the driving-end confirmation screen SH may further ask the user X whether or not to perform the remote monitoring of the vehicle 100. The user X uses the input device 220 to input whether or not to perform the remote monitoring. When the user X performs the remote monitoring, the control device 250 displays the above-described remote monitoring screen SD on the display device 230. On the other hand, when the user X does not perform the remote monitoring, the control device 250 displays the above-described selection screen SB on the display device 230. That is, when the user X does not perform the remote monitoring, the display screen is immediately switched to the selection screen SB without going through the remote monitoring screen SD.

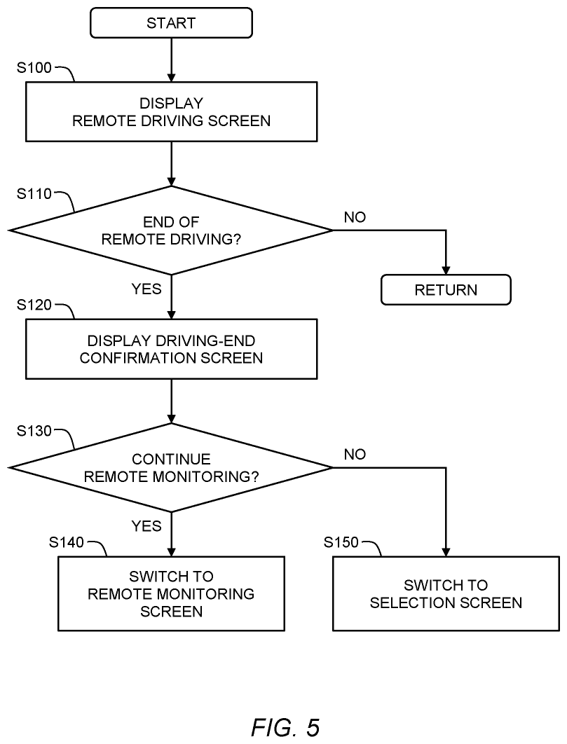

FIG. 5 is a flowchart illustrating processing related to the termination of the remote driving. During the remote driving of the vehicle 100, the control device 250 displays the remote driving screen SG (Step S100). When the user X terminates the remote driving (Step S110; Yes), the control device 250 displays the driving-end confirmation screen SH (Step S120). When the user X continues the remote monitoring of the vehicle 100 (Step S130; Yes), the control device 250 switches the display screen to the remote monitoring screen SD (Step S140). On the other hand, when the user X does not continue the remote monitoring of the vehicle 100 (Step S130; No), the control device 250 switches the display screen to the selection screen SB (Step S150).

### 3-6. Log-Out

When terminating the remote support for the vehicle 100, the user X performs a log-out operation by the use of the input device 220. For example, the selection screen SB includes a log-out button, and the user X presses the log-out button by the use of the input device 220. When the log-out operation is performed by the user X, the control device 250 displays the above-described authentication screen SA on the display device 230. That is, the control device 250 switches the display screen to the authentication screen SA.

When the log-out operation is performed by the user X, the control device 250 may display a log-out confirmation screen SZ on the display device 230. The user X confirms or cancels the log-out by the use of the input device 220. When the log-out is canceled, the display screen returns to the selection screen SB. On the other hand, when the log-out is confirmed, the display screen is switched to the authentication screen SA.

As a modification example, when a certain period of time has elapsed without the user X performing the remote support for the vehicle 100, the control device 250 may automatically perform the log-out operation. In this case, the control device 250 automatically switches the display screen to the authentication screen SA.

### 4. Effects

As described above, according to the present embodiment, displaying the remote support screen for the user X to perform the remote support for the vehicle 100 is prohibited until the authentication of the user X is completed. That is, the authentication of the user X is essential before the user X performs the remote support for the vehicle 100. Therefore, it is possible to prevent a situation in which an unqualified person operates the remote support terminal 200 without permission to perform the remote support for the vehicle 100. As a result, the security of the remote support for the vehicle 100 is improved.

Moreover, according to the present embodiment, the remote support screen includes the selection screen SB for the user X to select a vehicle 100 to be a target of the remote support. However, displaying the selection screen SB is prohibited until the authentication of the user X is completed. After the authentication of the user X is completed, the selection screen SB is displayed. Since the authentication of the user X is completed, it is possible to make the selection screen SB include only the group of vehicle candidates for which the authenticated user X is allowed to perform the remote support. Therefore, the user X is able to efficiently select the target of the remote support. As a comparative example, when the authentication of the user X is performed every time the user X selects a vehicle 100, efficiency and convenience are reduced.

Furthermore, in the modification example illustrated in FIG. 4, the remote support terminal 200 receives a remote driving request from a certain vehicle 100 before the authentication of the user X is completed. In this case, upon the authentication of the user X is completed, the display screen is immediately switched from the authentication screen SA to the remote driving screen SG. As a result, it is possible to quickly start the remote driving of the vehicle 100.

When the user X terminates the remote driving of the vehicle 100, whether or not the user X performs the remote monitoring of the vehicle 100 may be checked. When the user X does not perform the remote monitoring, the display screen is immediately switched to the selection screen SB without going through the remote monitoring screen SD. Therefore, the user X is able to immediately initiate a remote support for another vehicle 100. In other words, it is possible to shorten a time to start handling of another vehicle 100.

Further, when the log-out operation is performed, the display screen returns to the authentication screen SA. Thus, a plurality of users X is able to share a single remote support terminal 200.

What is claimed is:

1. A remote support terminal operated by a user performing a remote support for a moving body, the remote support terminal comprising:
a display; and
one or more processors configured to:
display an authentication screen for requesting authentication of the user on the display;
prohibit displaying a remote support screen for the user to perform the remote support for the moving body on the display until the authentication of the user is completed; and
display the remote support screen on the display after the authentication of the user is completed.

2. The remote support terminal according to claim 1, wherein
the remote support screen includes a selection screen for the user to select a moving body to be a target of the remote support,
the one or more processors are further configured to:
prohibit displaying the selection screen on the display until the authentication of the user is completed; and
permit displaying the selection screen on the display after the authentication of the user is completed.

3. The remote support terminal according to claim 1, wherein
the remote support screen includes:
a selection screen for the user to select a moving body to be a target of the remote support; and
a remote driving screen for the user to perform remote driving of the moving body, and
in a case where the remote support terminal receives a request for the remote driving from the moving body before the authentication of the user is completed, the one or more processors are configured to display the remote driving screen on the display without displaying the selection screen once the authentication of the user is completed.

4. The remote support terminal according to claim 1, wherein
the remote support screen includes:
a selection screen for the user to select a moving body to be a target of the remote support; and
a remote monitoring screen for the user to perform remote monitoring of the moving body,
when the user terminates remote driving of the moving body, the one or more processors are configured to display a confirmation screen for asking the user whether to perform the remote monitoring on the display,
when the user performs the remote monitoring, the one or more processors are configured to display the remote monitoring screen on the display, and
when the user does not perform the remote monitoring, the one or more processors are configured to display the selection screen on the display.

5. A terminal control method for controlling a remote support terminal operated by a user performing a remote support for a moving body, the terminal control method comprising:
displaying an authentication screen for requesting authentication of the user on a display of the remote support terminal;
prohibiting displaying a remote support screen for the user to perform the remote support for the moving body on the display until the authentication of the user is completed; and
displaying the remote support screen on the display after the authentication of the user is completed.
